(19) United States
(12) Patent Application Publication
(10) Pub. No.: US 2022/0105631 A1
(43) Pub. Date: Apr. 7, 2022

(54) ARTIFICIAL INTELLIGENCE MOVING ROBOT AND METHOD FOR CONTROLLING THE SAME

(71) Applicant: LG ELECTRONICS INC., Seoul (KR)

(72) Inventors: Hyungkook JOO, Seoul (KR); Jongil PARK, Seoul (KR); Kyuchun CHOI, Seoul (KR)

(73) Assignee: LG ELECTRONICS INC., Seoul (KR)

(21) Appl. No.: 17/310,349

(22) PCT Filed: Jan. 10, 2020
(86) PCT No.: PCT/KR2020/000463

§ 371 Date: Jul. 29, 2021

(30) Foreign Application Priority Data
Jan. 28, 2019 (KR) 10-2019-0010728

(51) Int. Cl. B25J 9/16

(52) U.S. Cl. CPC B25J 9/1666; B25J 9/1697

(57) ABSTRACT

The present disclosure relates to an artificial intelligence (AI) moving robot and a method for controlling the AI moving robot in which a target monitoring area is set based on recording information received from a monitoring element configured to monitor the travel area, and at least one of traveling of a main body and image capturing of an image capturing unit is controlled to monitor the target monitoring area for monitoring the travel area.

### CROSS-REFERENCE TO RELATED APPLICATIONS

This application is the National Stage filing under 35 U.S.C. 371 of International Application No. PCT/KR2020/000463, filed on Jan. 10, 2020, which claims the benefit of earlier filing date and right of priority to Korean Application No. 10-2019-0010728, filed on Jan. 28, 2019, the contents of which are all hereby incorporated by reference herein in their entirety.

### TECHNICAL FIELD

The present disclosure relates to a moving robot that autonomously travels in a travel area, and a method for controlling the moving robot.

### BACKGROUND ART

Generally, a moving robot is a device that automatically performs a predetermined operation while traveling by itself in a predetermined area without a user's operation. The moving robot senses obstacles located in the area and performs its operations by moving close to or away from such obstacles.

Such a lawn mower robot may include a cleaning robot that carries out cleaning while traveling in an area, as well as a lawn mower robot that mows the grass on a bottom of the area. Generally, lawn mower devices include a riding-type device that moves according to a user's operation to cut a lawn or perform weeding when the user rides on the device, and a work-behind type or hand type device that is manually pushed or pulled by the user to move and cut a lawn. Such lawn mower is moved by a direct control of the user to mow the lawn, which causes user's inconvenience in that the device is operated only directly by the user. Accordingly, research has been conducted on a moving robot-type mower device including elements that cuts a lawn.

Such a moving robot for lawn mowing (lawn mower) operates outdoors rather than indoors, and thus the moving robot for lawn mowing moves in a wider area compared to a moving robot traveling in an indoor area. In the case of indoors, a surface of the floor is monotonous (or flat), and factors such as terrain/objects affecting traveling of a moving robot are limited. On the other hand, as for outdoors, since it is an open space, there are many factors affecting traveling of a moving robot, and the traveling of the moving robot is greatly affected by the terrain. The moving robot traveling in such an outdoor environment may autonomously travel in a travel area to monitor a status (or condition) of the travel area. For example, the moving robot may monitor a stranger intruding the travel area or monitor any damage to structures in the travel area. However, it is not easy to set a monitoring path of the moving robot due to the nature of a wide outdoor environment, making it difficult to effectively monitor the wide outdoor environment.

Meanwhile, Korean Patent Laid-Open Publication No. 10-2018-0098891 (Published on Sep. 5, 2018) (hereinafter referred to as “related art document”) discloses a moving robot that travels to monitor a specific location in an indoor space. However, the moving robot disclosed in the related art document is limited to an indoor moving robot, and thus it is not suitable for a lawn mowing robot that travels in an outdoor environment. In other words, factors and constraints regarding the outdoor environment are not taken into consideration. Accordingly, a method for controlling a moving robot's traveling that takes structures in the outdoor environment into account is not provided.

In other words, in the related art moving robot, a technology for properly monitoring an area at risk for a break-in among a wide outdoor environment is not provided. As a result, there is a limitation in ensuring reliability and security of a travel area. In addition, in the field of moving robot technology, in general, a technology for obviating such limitations has not been provided, and thus, a limitation or problem caused by dynamic obstacles has not been solved.

### DISCLOSURE

### Technical Problem

Therefore, an aspect of the present disclosure is to obviate the above-mentioned problems and other drawbacks.

More particularly, an aspect of the present disclosure is to provide a moving robot capable of monitoring a travel area by being interconnected with a monitoring element, and a method for controlling the moving robot.

Another aspect of the present disclosure is to provide a moving robot that can effectively monitor a blind spot at risk for a break-in, and a method for controlling the moving robot.

Still another aspect of the present disclosure is to provide a moving robot capable of monitoring the entire travel area without any missing spot, and a method for controlling the moving robot.

### Technical Solution

Embodiments disclosed herein provide a moving robot and a method for controlling the moving robot that may monitor a travel area by communicating with another monitoring element installed in the travel area.

In detail, when the moving robot utilizing and employing an Artificial Intelligence (AI) technology monitors the travel area, or traveling of the moving robot is controlled to monitor the travel area, recording information may be received from another monitoring element through communication, and a target monitoring area may be set based on the recording information received, so that the moving robot monitors the target monitoring area by traveling in the target monitoring area while capturing an image.

That is, in the moving robot and the method for controlling the moving robot according to the present disclosure, a target monitoring area is set based on recording information received from the monitoring element, and at least one of traveling of a main body and image capturing of an image capturing unit is controlled to monitor the target monitoring area for monitoring the travel area.

Accordingly, in the moving robot and the method for controlling the moving robot according to the present disclosure, a blind spot may be monitored as well, and thus a travel area may be efficiently monitored, thereby addressing the above-mentioned problems.

The technical features herein may be implemented as a control element for a moving robot, a method for controlling a moving robot, a method for monitoring an area with a moving robot and a control method for monitoring an area, and a moving robot employing AI, a method for monitoring an area using AI, or the like. This specification provides embodiments of the moving robot and the method for controlling the moving robot having the above-described technical features.

In order to achieve the aspects and other advantages of the present disclosure, there is provided a moving robot including a main body, a driving unit moving the main body, an image capturing unit capturing an image around the main body to generate image information regarding a travel area of the main body, a communication unit communicating with a monitoring element installed in the travel area to receive recording information from the monitoring element, and a controller configured to control traveling of the main body by controlling the driving unit, and determine a status of the travel area based on the image information. When a mode is set to a monitoring mode in which the moving robot monitors the travel area while traveling, the controller may set a target monitoring area based on the recording information, and control at least one of traveling of the main body and image capturing of the image capturing unit to monitor the target monitoring area, so as to monitor the travel area.

In order to achieve the aspects and other advantages of the present disclosure, there is also provided a method for controlling a moving robot including a main body, a driving unit moving the main body, an image capturing unit capturing an image around the main body to generate image information of a travel area of the main body, a communication unit communicating with a monitoring element installed in the travel area to receive recording information from the monitoring element, and a controller configured to control traveling of the main body by controlling the driving unit and determine a status of the travel area based on the image information, the method may include receiving the recording information from the monitoring element, setting a target monitoring area based on the recording information, monitoring the target monitoring area by controlling the moving robot to travel and capture an image around the target monitoring area, and generating monitoring information of the travel area based on the recording information and a monitoring result.

### Advantageous Effects

In a moving robot and a method for controlling the moving robot according to the present disclosure, a specific area at risk for a break-in can be monitored intensively by communicating with a monitoring element installed in a travel area.

In addition, in the moving robot and a method for controlling the moving robot according to the present disclosure, a blind spot at high risk for a break-in can be effectively detected, thereby monitoring the entire travel area without any missing spot.

In addition, in the moving robot and a method for controlling the moving robot according to the present disclosure, a travel area, which is difficult to monitor periodically, can be easily monitored, thereby improving reliability and security of the travel area.

Thus, the moving robot and the method for controlling the moving robot according to the present disclosure can not only obviate limitations of the related art, but also improve accuracy, stability, reliability, applicability, efficiency, effectiveness, and utilization in the technical field of moving robots for lawn mowing utilizing and employing AI.

### BRIEF DESCRIPTION OF THE DRAWINGS

FIG. 1A is a configuration diagram (a) illustrating a moving robot according to one embodiment of the present disclosure.

FIG. 1B is a configuration diagram (b) illustrating a moving robot according to one embodiment of the present disclosure.

FIG. 1C is a configuration diagram (c) illustrating a moving robot according to one embodiment of the present disclosure.

FIG. 2 is a conceptual view illustrating one embodiment of a travel area of the moving robot according to the present disclosure.

FIG. 3A is a conceptual view illustrating a traveling principle of the moving robot according to the present disclosure.

FIG. 3B is a conceptual diagram illustrating a signal flow between devices to determine a position of the moving robot according to the present disclosure.

FIG. 4 is a detailed configuration diagram of the moving robot according to the present disclosure.

FIG. 5 is an exemplary view illustrating an example of moving robot's traveling in a travel area according an embodiment of the present disclosure.

FIG. 6 is a conceptual view illustrating communications between a communication unit and a monitoring element according to an embodiment of the present disclosure.

FIG. 7 is an exemplary view illustrating a monitoring area according to an embodiment of the present disclosure.

FIG. 8 is a conceptual view illustrating how a target monitoring area is determined according to an embodiment of the present disclosure.

FIG. 9 is a conceptual view illustrating how monitoring information is generated according to an embodiment of the present disclosure.

FIG. 10 is a flowchart illustrating a sequence for a method for controlling the moving robot according to the present disclosure.

### DETAILED DESCRIPTION

Hereinafter, embodiments of a moving robot system and a method for controlling the moving robot according the present disclosure will be described in detail with reference to the accompanying drawings, and the same reference numerals are used to designate the same/like components and redundant description thereof will be omitted.

In describing technologies disclosed in the present disclosure, if a detailed explanation for a related known function or construction is considered to unnecessarily divert the idea of the technologies in the present disclosure, such explanation has been omitted but would be understood by those skilled in the art. It should be noted that the attached drawings are provided to facilitate understanding of the technical idea disclosed in this specification, and should not be construed as limiting the technical idea by the attached drawings.

Hereinafter, an embodiment of a moving robot (hereinafter referred to as “robot”) according to the present disclosure will be described.

The robot may refer to a robot capable of autonomous traveling, a lawn-mowing moving robot, a lawn mowing robot, a lawn mowing device, or a moving robot for lawn mowing.

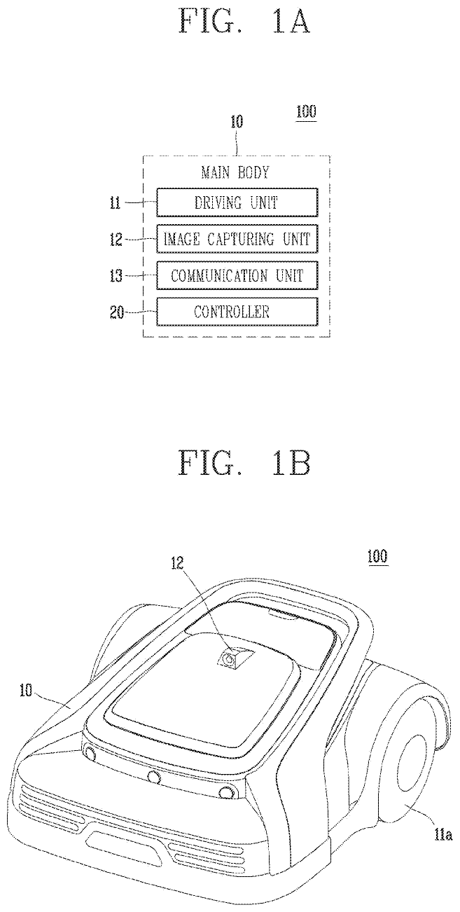

As shown in FIG. 1A, the robot 100 includes a main body 10, a driving unit 11 moving the main body 10, an image capturing unit 12 capturing an image of a periphery of the main body 10 to generate image information of a travel area 1000 of the main body 10, a communication unit 13 communicating with a monitoring element installed in the travel area 1000 to receive recording (or monitoring) information of the monitoring element, and a controller 20 controlling the driving unit 11 to control traveling of the main body 10 and determining a status (or condition) of the travel area 1000 based on the image information.

The controller 20 may determine the current position of the main body 10, control the driving unit 11 such that the main body 10 is controlled to travel in the travel area 1000, and control the image capturing unit 12 to capture an image of a periphery of the main body 10 while the main body 10 travels in the travel area 1000, allowing a status of the travel area 1000 to be determined based on the image information generated by of the image capturing unit 12.

As such, in the robot 100 including the main body 10, the driving unit 11, the image capturing unit 12, the communication unit 13, and the controller 20, the controller 20 sets a target area to be monitored (or target monitoring area) based on the recording information, and controls at least one of traveling of the main body 10 and image capturing of the image capturing unit 20 to monitor the travel area 1000, when a mode is set to a monitoring mode designed to monitor the travel area 1000.

In other words, in the robot 100, when the monitoring mode is set, the controller 20 controls traveling of the main body 10 to monitor the target monitoring area.

As shown in FIGS. 1B and 1C, the robot 100 may be an autonomous traveling robot including the main body 10 configured to be movable so as to cut a lawn. The main body 10 forms an outer shape (or appearance) of the robot 100 and includes one or more elements performing operations such as traveling of the robot 100 and lawn mowing. The main body 10 includes the driving unit 11 that may move the main body 10 in a desired direction and rotate the main body 10. The driving unit 11 may include a plurality of rotatable driving wheels. Each of the driving wheels may individually rotate so that the main body 10 rotates in a desired direction. In detail, the driving unit 11 may include at least one main driving wheel 11a and an auxiliary wheel 11b. For example, the main body 10 may include two main driving wheels 11a, and the two main driving wheels may be installed on a rear lower surface of the main body 10.

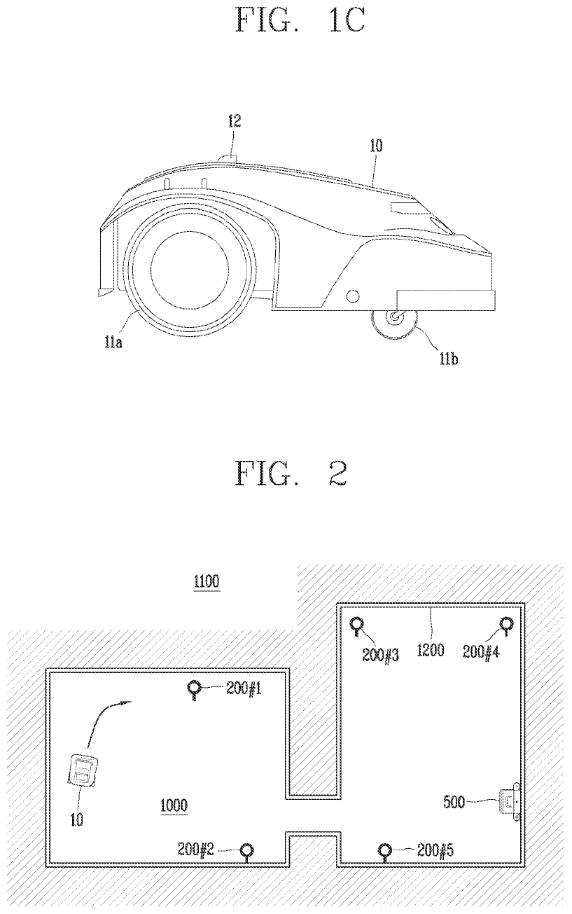

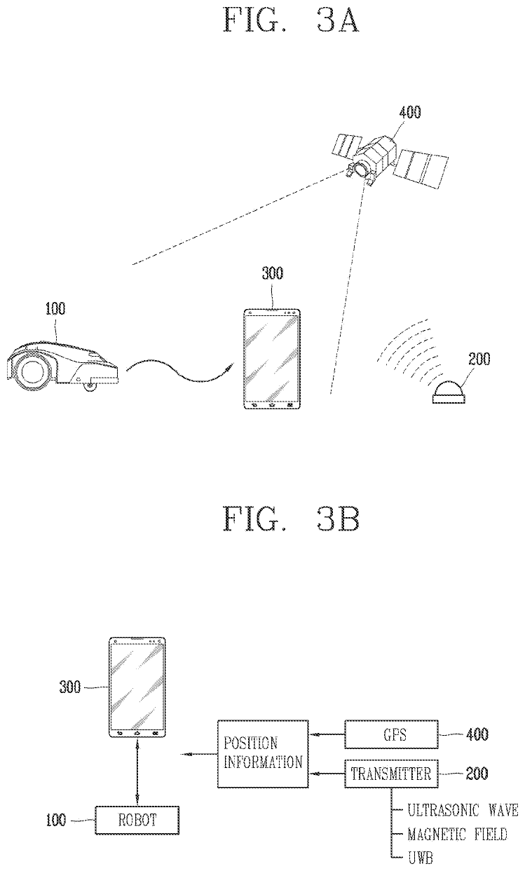

Accordingly, the robot 100 may travel by itself within a travel area 1000 as illustrated in FIG. 2. The robot 100 may perform a particular operation during traveling. Here, the particular operation may be an operation of cutting a lawn in the travel area 1000. The travel area 1000 is a target area in which the robot 100 is to travel and operate. A predetermined outside/outdoor area may be provided as the travel area 1000. For example, a garden, a yard, or the like in which the robot 100 is to cut a lawn may be provided as the travel area 1000. A charging apparatus 500 for charging the robot 100 with driving power may be installed in the travel area 1000. The robot 100 may be charged with driving power by docking with the charging apparatus 500 installed in the travel area 1000.

The travel area 1000 may be provided as a boundary area 1200 that is predetermined, as shown in FIG. 2. The boundary area 1200 corresponds to a boundary line between the travel area 1000 and an outside area 1100, and the robot 100 may travel within the boundary area 1200 not to deviate from the outside area 1100. In this case, the boundary area 1200 may be formed to have a closed curved shape or a closed-loop shape. Also, in this case, the boundary area 1200 may be defined by a wire 1200 formed to have a shape of a closed curve or a closed loop. The wire 1200 may be installed in an arbitrary area. The robot 100 may travel in the travel area 1000 having a closed curved shape formed by the installed wire 1200.

As shown in FIG. 2, a transmission device 200 may be provided in plurality in the travel area 1000. The transmission device 200 is a signal generation element configured to transmit a signal to determine position (or location) information of the robot 100. The transmission devices 200 may be installed in the travel area 1000 in a distributed manner. The robot 100 may receive signals transmitted from the transmission devices 200 to determine a current position of the robot 100 based on a result of the reception or determine position information regarding the travel area 1000. In this case, a receiver of the robot 100 may receive the transmitted signals. The transmission devices 200 may be provided in a periphery of the boundary area 1200 of the travel area 1000. Here, the robot 100 may determine the boundary area 1200 based on installed positions of the transmission devices 200 in the periphery of the boundary area 1200.

In the system 1000, the robot 100 may operate according to a driving mechanism (or principle) as shown in FIG. 2, or a signal may flow between devices for position determination as shown in FIG. 3B.

As shown in FIG. 3A, the robot 100 may communicate with the terminal 300 moving in a predetermined area, and travel by following a position of the terminal 300 based on data received from the terminal 300. The robot 100 may set a virtual boundary in a predetermined area based on position information received from the terminal 300 or collected while the robot 100 is traveling by following the terminal 300, and set an internal area formed by the virtual boundary as the travel area 1000. When the boundary area 1200 and the travel area 1000 are set, the robot 100 may travel in the travel area 1000 not to deviate from the boundary area 1200. According to cases, the terminal 300 may set the boundary area 1200 and transmit the boundary area 1200 to the robot 100. When the terminal 300 changes or expands an area, the terminal 300 may transmit changed information to the robot 100 so that the robot 100 may travel in a new area. Also, the terminal 300 may display data received from the robot 100 on a screen to monitor operation of the robot 100.

The robot 100 or the terminal 300 may determine a current position by receiving position information. The robot 100 and the terminal 300 may determine a current position based on a signal for position information transmitted from the transmission device 200 in the travel area 1000 or a global positioning system (GPS) signal obtained using a GPS satellite 400. The robot 100 and the terminal 300 may preferably determine a current position by receiving signals transmitted from three transmission devices 200 and comparing the signals with each other. That is, three or more transmission devices 200 may be preferably provided in the travel area 1000.

The robot 100 sets one certain point in the travel area 1000 as a reference position, and then calculates a position while the robot 100 is moving as a coordinate. For example, an initial starting position, that is, a position of the charging apparatus 500 may be set as a reference position. Alternatively, a position of one of the plurality of transmission devices 200 may be set as a reference position to calculate a coordinate in the travel area 1000. The robot 100 may set an initial position of the robot 100 as a reference position in each operation, and then determine a position of the robot 100 while the robot 100 is traveling. With respect to the reference position, the robot 100 may calculate a traveling distance based on rotation times and a rotational speed of a driving wheel, a rotation direction of a main body, etc. to thereby determine a current position in the travel area 1000. Even when the robot 100 determines a position of the robot 100 using the GPS satellite 400, the robot 100 may determine the position using a certain point as a reference position.

As shown in FIG. 3, the robot 100 may determine a present position based on position information transmitted from the transmission device 200 or the GPS satellite 400. The position information may be transmitted in the form of a GPS signal, an ultrasound signal, an infrared signal, an electromagnetic signal, or an ultra-wideband (UWB) signal. A signal transmitted from the transmission device 200 may preferably be a UWB signal. Accordingly, the robot 100 may receive the UWB signal transmitted from the transmission device 200, and determine a present position based on the UWB signal.

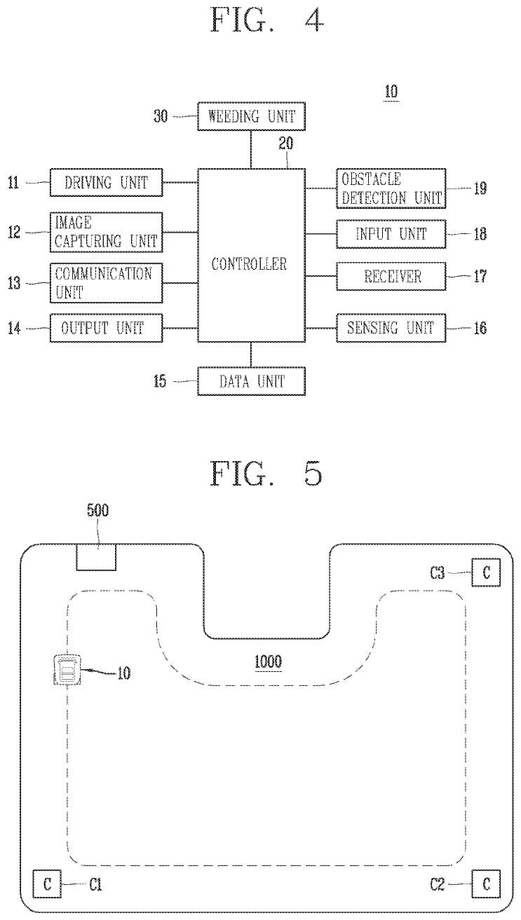

Referring to FIG. 4, the robot 100 operating as described above may include the main body 10, the driving unit 11, the image capturing unit 12, the communication unit 13, and the controller 20. When the monitoring mode is set, the robot 100 may travel in the travel area 1000 to monitor the target monitoring area set based on the recording information. Also, the robot 100 may further include at least one selected from an output unit 14, a data unit 15, a sensing unit 16, a receiver 17, an input unit 18, an obstacle detection unit 19, and a weeding unit 30.

The driving unit 11 is a driving wheel included in a lower part of the main body 10, and may be rotationally driven to move the main body 10. That is, the driving unit 11 may be driven so that the main body 10 travels in the travel area 1000. That is, the driving unit 11 may be driven such that the main body 10 travels in the travel area 1000. The driving unit 11 may include at least one driving motor to move the main body 10 so that the robot 100 travels. For example, the driving unit 11 may include a left wheel driving motor for rotating a left wheel and a right wheel driving motor for rotating a right wheel.

The driving unit 11 may transmit information about a driving result to the controller 20, and receive a control command for operation from the controller 20. The driving unit 11 may operate according to the control command received from the controller 20. That is, the driving unit 11 may be controlled by the controller 20.

The image capturing unit 12 may be a camera capturing a periphery of the main body 10. The image capturing unit 12 may capture an image of a forward direction of the main body 10 to detect an obstacle around the main body 10 and in the travel area 1000. The camera is a digital camera, and may include an image sensor (not shown) and an image processing unit (not shown). The image sensor is a device that converts an optical image into an electrical signal. The image sensor includes a chip in which a plurality of photodiodes is integrated. A pixel may be an example of a photodiode. Electric charges are accumulated in the respective pixels by an image, which is formed on the chip by light that has passed through a lens, and the electric charges accumulated in the pixels are converted to an electrical signal (for example, a voltage). A charge-coupled device (CCD) sensor and a complementary metal oxide semiconductor (CMOS) sensor are well known as image sensors. In addition, the camera may include a Digital Signal Processor (DSP) for the image processing unit to process a captured image in order to generate the image information.

The image capturing unit 16 may transmit information about a result of the image capturing to the controller 20, and receive a control command for operation from the controller 20. The image capturing unit 16 may operate according to the control command received from the controller 20. That is, the image capturing unit 16 may be controlled by the controller 20.

The communication unit 13 may communicate with at least one communication element that is to communicate the robot 100. The communication unit 13 may communicate with the transmission device 200 and the terminal 200 using a wireless communication method. The communication unit 13 may be connected to a predetermined network so as to communicate with the terminal 300 that controls an external server or the robot 100. When the communication unit 13 communicates with the terminal 300, the communication unit 13 may transmit a generated map to the terminal 300, receive a command from the terminal 300, and transmit data regarding an operation state of the robot 100 to the terminal 300. The communication unit 13 may include a communication module such as wireless fidelity (Wi-Fi), wireless broadband (WiBro), or the like, as well as a short-range wireless communication module such as Zigbee, Bluetooth, or the like, to transmit and receive data.

The communication unit 13 may transmit information about a result of the communication to the controller 20, and receive a control command for operation from the controller 20. The communication unit 13 may operate according to the control command received from the controller 20. That is, the communication unit 13 may be controlled by the controller 20.

The output unit 14 may include an output element such as a speaker to output an operation state of the robot 100 in the form of a voice (audio). The output unit 14 may output an alarm when an event occurs while the robot 100 is moving. For example, when the power is run out, an impact or shock is applied to the robot 100, or an accident occurs in the travel area 1000, an alarm voice may be output so that the corresponding information is provided to the user.

The output unit 14 may transmit information about an operation state to the controller 20 and receive a control command for operation from the controller 20. The output unit 14 may operate according to a control command received from the controller 20. That is, the output unit 14 may be controlled by the controller 20.

The data unit 15 is a storage element that stores data readable by a microprocessor, and may include a hard disk drive (HDD), a solid state disk (SSD), a silicon disk drive (SDD), a read only memory (ROM) a random access memory (RAM), CD-ROM, a magnetic tape, a floppy disk, or an optical data storage device. In the data unit 15, a received signal may be stored, reference data to determine an obstacle may be stored, and obstacle information regarding a detected obstacle may be stored. In the data unit 15, control data that controls operation of the robot 100, data according to an operation mode of the robot 100, position information collected, and information about the travel area 1000 and the boundary area 1200 may be stored.

The sensing unit 16 may include at least one sensor that senses information about a posture and operation of the main body 10. The sensing unit 16 may include at least one selected from an inclination sensor that detects movement of the main body 10 and a speed sensor that detects a driving speed of the driving unit 11. The inclination sensor may be a sensor that senses posture information of the main body 10. When the main body 10 is inclined forward, backward, leftward or rightward, the inclination sensor may sense the posture information of the main body 10 by calculating an inclined direction and an inclination angle. A tilt sensor, an acceleration sensor, or the like may be used as the inclination sensor. In a case of the acceleration sensor, any of a gyro type sensor, an inertial type sensor, and a silicon semiconductor type sensor may be used. In addition, various sensors or devices capable of detecting movement of the main body 10 may be used. The speed sensor may be a sensor for sensing a driving speed of a driving wheel in the driving unit 11. When the driving wheel rotates, the speed sensor may sense the driving speed by detecting rotation of the driving wheel.

The sensing unit 16 may transmit information about a sensing result to the controller 20, and receive a control command for operation from the controller 20. The sensing unit 16 may operate according to a control command received from the controller 20. That is, the sensing unit 18 may be controlled by the controller 20.

The receiver 17 may include a plurality of signal sensor modules that transmits and receives the position information. The receiver 17 may include a position sensor module that receives the signals transmitted from the transmission device 200. The position sensor module may transmit a signal to the transmission device 200. When the transmission device 200 transmits a signal using a method selected from an ultrasound method, a UWB method, and an infrared method, the receiver 17 may include a sensor module that transmits and receives an ultrasound signal, a UWB signal, or an infrared signal, in correspondence with this. The receiver 17 may include a UWB sensor. As a reference, UWB radio technology refers to technology using a very wide frequency range of several GHz or more in baseband instead of using a radio frequency (RF) carrier. UWB wireless technology uses very narrow pulses of several nanoseconds or several picoseconds. Since pulses emitted from such a UWB sensor are several nanoseconds or several picoseconds long, the pulses have good penetrability. Thus, even when there are obstacles in a periphery of the UWB sensor, the receiver 17 may receive very short pulses emitted by other UWB sensors.

When the robot 100 travels by following the terminal 300, the terminal 300 and the robot 100 include the UWB sensor, respectively, thereby transmitting or receiving a UWB signal with each other through the UWB sensor. The terminal 300 may transmit the UWB signal to the robot 100 through the UWB sensor included in the terminal 300. The robot 100 may determine a position of the terminal 300 based on the UWB signal received through the UWB sensor, allowing the robot 100 to move by following the terminal 300. In this case, the terminal 300 operates as a transmitting side and the robot 100 operates as a receiving side. When the transmission device 200 includes the UWB sensor and transmits a signal, the robot 100 or the terminal 300 may receive the signal transmitted from the transmission device 200 through the UWB sensor included in the robot 100 or the terminal 300. At this time, a signaling method performed by the transmission device 200 may be identical to or different from signaling methods performed by the robot 100 and the terminal 300.

The receiver 17 may include a plurality of UWB sensors. When two UWB sensors are included in the receiver 17, for example, provided on left and right sides of the main body 10, respectively, the two USB sensors may receive signals, respectively, and compare a plurality of received signals with each other to thereby calculate an accurate position. For example, according to a position of the robot 100, the transmission device 200, or the terminal 300, when a distance measured by a left sensor is different from a distance measured by a right sensor, a relative position between the robot 100 and the transmission device 200 or the terminal 300, and a direction of the robot 100 may be determined based on the measured distances.

The receiver 17 may further include a GPS module for transmitting and receiving a GPS signal from the GPS satellite 400.

The receiver 17 may transmit the reception result of the signal to the controller 20, and receive a control command for operation from the controller 20. The receiver 17 may operate according to the control command received from the controller 20. That is, the receiver 17 may be controlled by the controller 20.

The input unit 18 may include at least one input element such as a button, a switch, a touch pad, or the like, and an output element such as a display, or the like to receive a user command and output an operation state of the robot 100. For example, a command for performing the monitoring mode may be input through the display unit, and a state for performing the monitoring mode may be output through the display unit.

The input unit 18 may display a state of the robot 100 through the display unit, and display a control screen on which a control manipulation of the robot 100 is input. The control screen may mean a user interface screen on which a driving state of the robot 100 is displayed and output, and a command for driving operation of the robot 100 is input from a user. The control screen may be displayed on the display unit under the control of the controller 20, and a display and an input command on the control screen may be controlled by the controller 20.

The input unit 18 may transmit information about an operation state to the controller 20 and receive a control command for operation from the controller 20. The input unit 18 may operate according to a control command received from the controller 20. That is, the input unit 18 may be controlled by the controller 20.

The obstacle detection unit 19 includes a plurality of sensors to detect obstacles located in a traveling direction. The obstacle detection unit 19 may detect an obstacle located in a forward direction of the main body 10, that is, in a traveling direction of the main body 10 using at least one selected from a laser sensor, an ultrasonic sensor, an infrared sensor, and a three-dimensional (3D) sensor. The obstacle detection unit 19 may further include a cliff detection sensor installed on a rear surface of the main body 10 to detect a cliff.

The obstacle detection unit 19 may transmit information about a result of the detection to the controller 20, and receive a control command for operation from the controller 20. The obstacle detection unit 19 may operate according to the control command received from the controller 20. That is, the obstacle detection unit 19 may be controlled by the controller 20.

The weeding unit 30 cuts the bottom of a grass while traveling. The weeding unit 30 is provided with a brush or blade for cutting a lawn, so as to cut the bottom of a lawn in a rotating manner.

The weeding unit 30 may transmit information about a result of operation to the controller 20 and receive a control command for operation from the controller 20. The weeding unit 30 may operate according to the control command received from the controller 20. That is, the weeding unit 30 may be controlled by the controller 20.

The controller 20 may include a central processing unit to control all operations of the robot 100. The controller 20 may determine a particular point in the travel area 1000 at which traveling of the main body 10 is limited, i.e., a condition of the travel area 1000, via the main body 10, the driving unit 11, and the image capturing unit 12, and control functions/operations of the robot 100 to be performed via the communication unit 13, the output unit 14, the data unit 15, the sensing unit 16, the receiver 17, the obstacle detection unit 18, and the weeding unit 30.

The controller 20 may control input and output of data and control the driving unit 11 so that the main body 10 travels according to settings. The controller 20 may independently control operations of the left wheel driving motor and the right wheel driving motor by controlling the driving unit 11 to thereby control the main body 10 to travel rotationally or in a straight line.

The controller 20 may set the boundary area 1200 of the travel area 1000 based on position information received from the terminal 300 or position information determined based on the signal received from the transmission device 200. The controller 20 may also set the boundary area 1200 of the travel area 1000 based on position information that is collected by the controller 20 during traveling. The controller 20 may set a certain area of a region formed by the set boundary area 1200 as the travel area 1000. The controller 20 may set the boundary area 1200 in a closed loop form by connecting discontinuous position information in a line or a curve, and set an inner area within the boundary area 1200 as the travel area 1000. When the travel area 1000 and the border area 1200 corresponding thereto are set, the controller 20 may control traveling of the main body 10 so that the main body 10 travels in the travel area 1000 without deviating from the set boundary area 1200. The controller 20 may determine a current position based on received position information and control the driving unit 11 so that the determined current position is located in the travel area 1000 to thereby control traveling of the main body 10.

In addition, according to obstacle information input by at least one of the image capturing unit 12, and the obstacle detection unit 19, the controller 20 may control traveling of the main body 10 to avoid obstacles and travel. In this case, the controller 20 may modify the travel area 1000 by reflecting the obstacle information to pre-stored area information regarding the travel area 1000.

In the robot 100 having the configuration as illustrated in FIG. 4, when the monitoring mode is set, the controller 20 may set the target monitoring area based on the recording information received from the monitoring element, and control at least on of traveling of the main body 10 and image capturing of the image capturing unit 12 to monitor the target monitoring area of the travel area 1000.

The robot 100 may perform a set operation while traveling in the travel area 1000. For example, the robot 100 may cut a lawn on a bottom of the travel area 1000 as shown in FIG. 5 while traveling in the travel area 1000.

In the robot 100, the main body 10 may travel according to driving of the driving unit 11. The main body 10 may travel as the driving unit 11 is driven to move the main body 10.

In the robot 100, the driving unit 11 may move the main body 10 according to driving of driving wheels. The driving unit 11 may move the main body 10 by driving the driving wheels so that the main body 10 travels.

In the robot 100, the image capturing unit 12 may capture an image of a periphery of the main body 10 from a position where it is installed. The image capturing unit 12 may be provided at an upper portion of a rear side of the main body 10. By providing the image capturing unit 12 at the upper portion of the rear side of the main body 10, the image capturing unit 12 may be prevented from being contaminated by foreign material or dust generated by traveling of the main body and lawn cutting. The image capturing unit 12 may capture an image of a traveling direction of the main body 10. That is, the image capturing unit 12 may capture an image of a forward direction of the main body 10 to travel. The image capturing unit 12 may capture an image around the main body 10 in real time to generate the image information. In addition, the image capturing unit 12 may transmit a result of image capturing to the controller 20 in real time. Accordingly, the controller 20 may determine a real-time status of the travel area 1000.

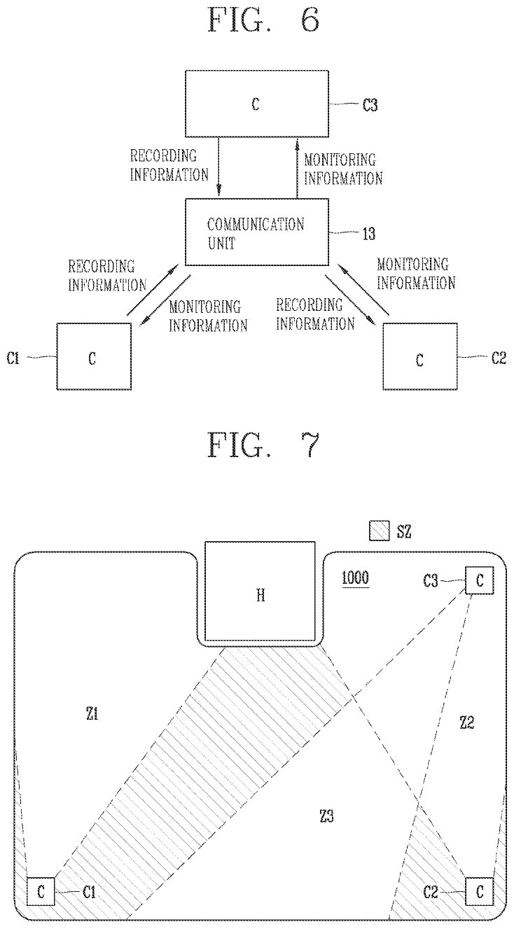

In the robot 100, the communication unit 13 may communicate with a communication target element of the robot 100. The communication unit 13 may communicate with at least one communication target element that is to communicate the robot 100. Here, the communication target element may include at least the monitoring element. The monitoring element C may be a monitoring (or surveillance) camera that records and monitors a predetermined area from an installed position. For example, it may be a Closed-Circuit Television (CCTV), a black box, and the like. As illustrated in FIG. 5, the monitoring element C may be provided in plurality, and thus a first monitoring element C1, a second monitoring element C2, and a third monitoring element C3 may be installed in the travel area 1000. The plurality of monitoring elements is installed at different locations in the travel area 1000 to record and monitor respective areas. The monitoring elements may store a result of recording the respective areas as recording information. The monitoring elements may communicate with an external control element for controlling the monitoring elements, and transmit the recording information to the communication target element. Here, the control element may be at least one of the communication target elements communicating with the robot 100. The control element may also be the robot 100. That is, the monitoring elements may communicate with the robot 100. The monitoring elements C may monitor the respective areas in real time and transmit a result of monitoring to the communication unit 13. As illustrated in FIG. 6, the communication unit 13 may communicate with the monitoring elements C1 to C3 to receive recording information from each of the monitoring elements C1, C2, and C3. The communication unit 13 may also transmit information regarding the robot 100, such as monitoring information in the monitoring mode, to the monitoring elements C1 to C3. That is, the communication unit 13 may transmit and receive data to and from the monitoring elements C1, C2, and C3, respectively.

In the robot 100, the controller 20 may control the driving unit 11 such that the main body 10 is controlled to travel in the travel area 1000, and, based on the recording information, determine a status of the travel area 1000 to monitor the travel area 1000. When an execution command for the monitoring mode, designed to monitor the travel area 1000, is input through the communication unit 13 or the input unit 18, an operation mode of the robot 100 is set to the monitoring mode, so that the controller 20 controls at least one of traveling of the main body 10 and image capturing of the image capturing unit 12 according to the monitoring mode.

When the monitoring mode is set, the controller 20 sets a target monitoring area SZ in the travel area 1000 based on the recording information transmitted from the monitoring elements C, so that at least one of traveling of the main body 10 and image capturing of the image capturing unit 12 is controlled to monitor the target area SZ.

The monitoring mode is one of the operation modes of the robot 100, which may be a mode in which the controller 20 controls operation of the robot 100. The monitoring mode may be a mode for intensively monitoring, i.e., while the robot 100 travels in the travel area 1000, the robot 100 travels and captures an image around the target monitoring area SZ to intensively monitor the target monitoring area SZ. When the operation of the robot 100 is controlled by controller 20 according to the monitoring mode, the controller 20 may control at least one of traveling of the main body 10 and image capturing of the image capturing unit 12, so as to monitor the target monitoring area SZ intensively. That is, the monitoring mode may be a mode in which the robot 100 travels in the travel area 1000 to intensively monitor the target monitoring area SZ of the travel area 1000.

Here, the intensive monitoring may mean monitoring the target monitoring area SZ according to predetermined criteria (or references). For example, it may mean setting a priority among a monitoring time, a monitoring method, and a monitoring range of the target monitoring area SZ of the travel area 1000 for monitoring. The intensive monitoring may also mean monitoring only the target area SZ of the travel area 1000.

In the monitoring mode, the robot 100 may travel in the target monitoring area SZ differently according to a time period. That is, the monitoring mode may be executed differently according to the time period. For example, when the monitoring mode is executed in a first time period, it is performed by a first (travelling) mode, and when the monitoring mode is executed in a second time period, it is performed by a second (traveling) mode. Here, the time period and the traveling mode may be preset according to an environment in which the robot 100 is used. For example, the first time period is set from sunrise to sunset, and the second time period is set from sunset to sunrise. Visual indicators of the robot 100 may be deactivated in the first mode, and may be activated in the second mode. When the robot 100 travels in a preset reference time, the monitoring mode may be set to activate the visual indicators indicating that the robot 100 is traveling in the target area SZ according to the monitoring mode. Here, the reference time may be a night time period. Accordingly, when the robot 100 travels in the reference time, the monitoring mode may be set to activate the visual indicators showing that the robot 100 is traveling in the target area SZ. In the monitoring mode, when the robot 100 travels in the target area SZ in the reference time, the controller 20 may control to restrict operations other than traveling of the main body 10 and image capturing of the image capturing unit 12. In other words, when robot 100 travels in the target monitoring area SZ in the reference time according to the monitoring mode, the controller 20 may control the robot 100 to travel in the target monitoring area SZ by restricting operations other than traveling of the main body and image capturing of the image capturing unit 12. For example, in the night time period, the controller 20 may control to disable the weeding operation of the weeding unit 30, and to only enable the traveling of the main body 10 and the image capturing of the image capturing unit 12.

The controller 20 may determine a recording area Z of the monitoring elements C based on the recording information, and set the target monitoring area SZ based on the recording area Z. As illustrated in FIG. 7, the recording area Z may mean, among the travel area 1000, an area that is recorded and monitored by the monitoring elements C. The controller 20 may determine a recording area Z of each of the monitoring elements C based on recording information of the respective monitoring elements C, and set the target monitoring area SZ according to the determined recording area Z of the respective monitoring elements C. In more detail, based on the recording information received from the first monitoring element C1, the second monitoring element C2, and the third monitoring element C3, a first recording area Z1 of the first monitoring element C1, a second recording area Z2 of the second monitoring element C2, and a third monitoring area Z3 of the third monitoring element C3 are determined to set the target monitoring area SZ. Among the travel area 1000, the controller 20 may set an area except the recording area Z as the target monitoring area SZ. In other words, the target monitoring area SZ may be an area that is not recorded by the monitoring elements C. For example, as shown in FIG. 7, the target monitoring area SZ may be a location (or spot) that does not correspond to the first, second, and third recording areas Z1, Z2, and Z3 of the respective monitoring elements C1, C2, and C3. Accordingly, in the monitoring mode, the controller 20 may determine a blind spot that is excluded from the recording area Z of the travel area 1000 based on the recording area Z, and set the determined blind spot as the target monitoring area SZ, so as to be monitored as well.

The controller 20 may control the main body 10 to travel in the target monitoring area SZ and the image capturing unit 12 to capture an image of the target monitoring area SZ according to a preset monitoring reference. That is, when the robot 100 operates in the monitoring mode, the robot 100 may travel around the target monitoring area SZ while capturing an image according to the monitoring reference, so as to intensively monitor the target area SZ. The monitoring reference may be a reference for intensively monitoring the target monitoring area SZ. The monitoring reference may be a reference for the robot 100 to travel and capture an image around the target area SZ to monitor the target monitoring area SZ intensively.

The monitoring reference may be set to travel around the target monitoring area SZ in a predetermined traveling pattern. The traveling pattern may be a pattern for the main body 10 to travel around the target monitoring area SZ. For example, it may be rotating around the target monitoring area SZ or repeatedly traveling around the target monitoring area SZ. Accordingly, the controller 20 may control the main body 10 to travel around the target monitoring area SZ according to the traveling pattern.

In addition, the monitoring reference may be set to capture an image around the target monitoring area SZ in a predetermined capturing pattern. The capturing pattern may be a pattern for capturing an image of a periphery of the target monitoring area SZ. For example, it may be capturing an image around the target monitoring area SZ or repeatedly capturing an image around the target monitoring area SZ. Accordingly, the controller 20 may control the image capturing unit 12 to capture an image around the target monitoring area SZ according to the capturing pattern.

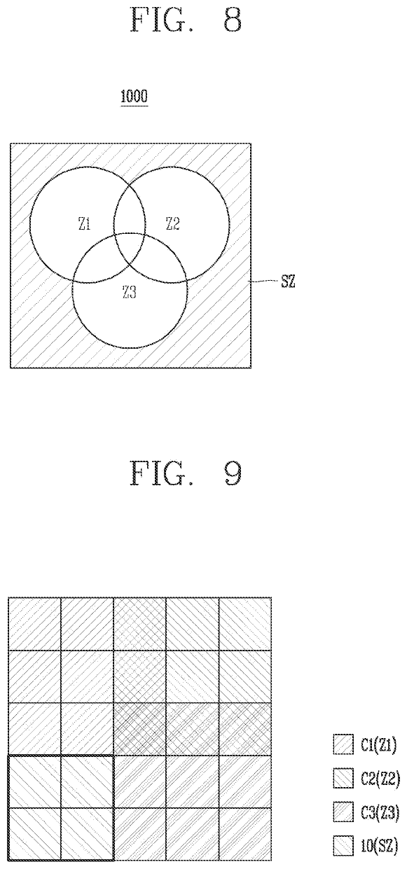

When the monitoring mode is set, the controller 20 controls at least one of the traveling of the main body 10 and the image capturing of the image capturing unit 12 to monitor the target monitoring area SZ. As shown in FIG. 8, the controller 20 sets an area that does not correspond to the recording area Z as the target monitoring area SZ, so as to monitor the area (or blind spot) of the travel area 1000, which is not monitored by the monitoring elements C.

Monitoring mode settings may be changed. In more detail, the controller 20 may change settings by reflecting at least one of a usage pattern (or use) of a structure (or a fixture) in the travel area 1000 and information of a user (or owner) of the travel area 1000. For example, the controller 20 may change a target monitoring area SZ setting according to at least one of results of analyzing the usage pattern and analyzing the user information based on the recording information or a monitoring reference setting. For example, a structure frequently used by the user of the robot 100 may be excluded from the target monitoring SZ setting or be excluded from a target for monitoring according to the monitoring reference. As such, the controller 20 may learn information of an environment (or condition) for using the robot 100 based on at least one of the usage pattern and the user information, and change the monitoring mode settings according to a result of learning, or change execution of the monitoring mode. That is, the robot 100 may be controlled by the controller 20 via artificial intelligence (AI).

As such, when the monitoring mode is set, the controller 20 that controls to monitor the target monitoring area SZ so as to monitor the travel area 1000, may generate monitoring information of the travel area 1000 based on the recording information and a monitoring result in the monitoring mode, and transmit the monitoring information to the communication target element and the monitoring elements C communicating with the communication unit 13. Here, the communication target element may be the terminal 300 of the user, and the like. In more detail, the controller 20 may generate monitoring information of the travel area 1000 based on a result of monitoring the target monitoring area SZ that is not monitored by the monitoring elements C and the recording information, so that information of the monitoring result is provided to the user of the robot 100 via the communication unit 13. In addition, the monitoring information may be transmitted to the monitoring elements C, allowing the monitoring elements C to monitor the travel area 1000 based on the monitoring information received.

As illustrated in FIG. 9, the controller 20 may generate the monitoring information regarding the travel area 1000 based on information of recording the recording area Z by the monitoring elements C and the result of monitoring target monitoring area SZ. In other words, the controller 20 may generate the monitoring information of the entire travel area 1000 based on the recording information of the recording area Z and the result of monitoring the target monitoring area SZ that corresponds to a ‘non-recording area’.

When the controller 20 senses a moving object in the target area SZ, the controller 20 may generate notification information of a sensed result, and transmit the notification information to the terminal 300. In other words, the controller 20 may provide information of the detected result to the user of the robot 100 via the communication unit 13 when the travel area 1000 is monitored. For example, when a stranger (or intruder) enters the target monitoring area SZ, changes in position of the stranger may be sensed from the periphery of the target monitoring area SZ, so that the sensed result is provided to the user of the robot 100 via the communication unit 13.

The robot 100 may further include the output unit 14 configured to outputting a voice, so that the controller 20 outputs a voice through the output unit 14 by generating an alarm signal, when a moving object in the target monitoring area SZ is sensed. For example, an alarm sound may be output to notify a break-in. That is, when the controller 20 senses a moving object in the periphery of the target monitoring area SZ, which is an area at risk for a break-in, an alarm sound notifying the break-in may be output via the output unit 14.

The robot 100 may further include the data unit 15 in which history (or record) information of monitoring the travel area 1000 is stored, and the controller 20 may generate monitoring information regarding a result of monitoring the travel area 1000. The controller 20 may update the history information by storing the monitoring information into the pre-stored history information in the data unit 15. In other words, the controller 20 may accumulate data of monitoring the travel area 1000 by storing the monitoring information into the history information. As such, the controller 20 that generates the monitoring information and stores the monitoring information in the storage unit 15 compares the monitoring information with the history information to detect a change in a status of the travel area 1000. Here, the controller 20 may further store a result of detecting the status change into the history information, and provide the result of detecting the status change to the user of the robot 100 via the communication unit 13.

The robot 100 as described above may be implemented in a method for controlling a moving robot (hereinafter referred to as “control method”) to be described hereinafter.

The control method is a method for controlling the moving robot 100 as shown in FIGS. 1A to 1C, which may be applied to the robot 100. It may also be applied to robots other than the robot 100.

The control method may be a method of controlling the robot 100 including the main body 10, the driving unit 11 moving the main body 10, the image capturing unit 12 capturing an image in a periphery of the main body 10 and generating image information of the travel area 1000 of the main body 10, the communication unit 13 communicating with the monitoring elements C installed in the travel area 100 and receiving information of recording by the monitoring elements C, and the controller 20 controlling the driving unit 11 to control traveling of the main body 10 and determining a status (or condition) of the travel area 1000 based on the image information, which may be a method in which the robot 100 monitors the travel area 1000 while traveling.

The control method may be a method in which the controller 20 controls operation of the robot 100 to perform the monitoring mode.

The control method may be a method performed by the controller 20.

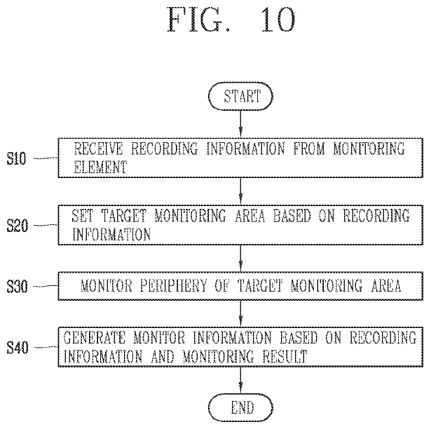

As shown in FIG. 10, the control method may include receiving the recording information from the monitoring elements C (S10), setting a target monitoring area SZ based on the recording information (S20), and monitoring the target monitoring area SZ by controlling the robot 100 to travel and capture an image around the target monitoring area SZ (S30), and generating monitoring information of the travel area 1000 based on the recording information and a result of the monitoring (S40).

That is, the robot 100 may perform the monitoring mode in order from the receiving (S10), the setting (S20), the monitoring (S30), to the generating (S40).

In the receiving step S10, the robot 100 is set to perform the monitoring mode, and the communication unit 13 receives the recording information from the monitoring elements C.

In the receiving step S10, the recording information may be transmitted from each of the monitoring elements C.

In the setting step S20, the controller 20 may set the target monitoring area SZ in the travel area 1000 based on the recording information received from the monitoring elements C at the receiving step S10.

In the setting step S20, the target monitoring area SZ may be set by determining a recording area Z of the monitoring elements C based on the recording information.

In the setting step S20, the recording area Z of each of the monitoring elements C is determined based on the recording information of the respective monitoring elements C, and the target monitoring area SZ may be set based on the respective recording areas Z determined.

In the setting step S20, among the travel area 1000, an area except the recording area Z may be set as the target monitoring area SZ.

In the monitoring step (S30), the controller 20 may control the traveling of main body 10 and image capturing of the image capturing unit 11, so that the target monitoring area SZ set at the setting step S20 may be intensively monitored.

In the monitoring step S30, the main body 10 and the image capturing unit 12 may be controlled to travel and capture around the target monitoring area SZ of the travel area 1000 according to a predetermined monitoring reference.

In the monitoring step S30, the main body 10 may be controlled to travel around the target monitoring area SZ according to a predetermined traveling pattern, so as to intensively monitor the target monitoring area SZ.

In the monitoring step S30, the image capturing unit 12 may be controlled to capture an image around the target monitoring area SZ according to a predetermined image capturing pattern, so as to intensively monitor the target monitoring area SZ.

The generating step S40 may be a step in which the controller 20 generates the monitoring information based on a result of monitoring at the monitoring step S30.

In the generating step (S40), monitoring information of the travel areal 1000 may be generated based on the recording information and the monitoring result to transmit the monitoring information to the communicating target element and the monitoring elements C communicating with the communication unit 13.

The control method that includes the receiving (S10), the setting (S20), the monitoring (S30), and the generating (S40) can be implemented as computer-readable codes on a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. The computer-readable medium may also be implemented as a format of carrier wave (e.g., transmission via an Internet). In addition, the computer may also include the controller 20.

As described above, a moving robot and a method for controlling the moving robot according to the present disclosure may be applied and implemented with respect to a control element for a moving robot, a moving robot system, a control system of a moving robot, a method for controlling a moving robot, a method for monitoring an area of a moving robot, and a control method of monitoring an area of a moving robot, etc. In particular, the above-described embodiments may be usefully applied and implemented with respect to Artificial Intelligence (AI) for controlling a moving robot, a control element for a moving robot employing and utilizing AI, and a control method for a moving robot employing and utilizing AI, a moving robot employing and utilizing AI, or the like. However, the technology disclosed in this specification is not limited thereto, and may be implemented in any moving robot, a control element for a moving robot, a moving robot system, a method for controlling a moving robot, or the like to which the technical idea of the above-described technology may be applied.

While the present disclosure has been particularly shown and described with reference to embodiments thereof, it will be understood that various changes in form and details may be made therein without departing from the spirit and scope of the present disclosure as defined by the following claims. Therefore, the scope of the present disclosure should not be limited by the described embodiments, but should be determined by the scope of the appended claims and equivalents thereof.

While the present disclosure has been particularly shown and described with reference to exemplary embodiments, described herein, and drawings, it may be understood by one of ordinary skill in the art that various changes and modifications thereof may be made. Therefore, the scope of the present disclosure should be defined by the following claims, and various changes equal or equivalent to the claims pertain to the category of the concept of the present disclosure.

What is claimed is:

1. A moving robot, comprising:
a main body;
a driving unit moving the main body;
an image capturing unit capturing an image around the main body to generate image information regarding a travel area of the main body;
a communication unit communicating with a monitoring element installed in the travel area to receive recording information from the monitoring element; and
a controller configured to control traveling of the main body by controlling the driving unit, and determine a status of the travel area based on the image information,
wherein the controller, when a mode is set to a monitoring mode in which the moving robot monitors the travel area while traveling, sets a target monitoring area based on the recording information, and controls at least one of traveling of the main body and image capturing of the image capturing unit to monitor the target monitoring area, so as to monitor the travel area.

2. The moving robot of claim 1, wherein the image capturing unit is provided at an upper portion of a rear side of the main body to capture an image of a traveling direction of the main body.

3. The moving robot of claim 1, wherein the communication unit communicates with one or more of the monitoring elements, and receives recording information from each of the monitoring elements.

4. The moving robot of claim 1, wherein the monitoring mode is a mode in which the moving robot travels and captures around the target monitoring area while traveling in the travel area, so as to intensively monitors the target monitoring area.

5. The moving robot of claim 4, wherein the monitoring mode is configured that the moving robot travels in the target monitoring area differently according to a time period.

6. The moving robot of claim 5, wherein the monitoring mode is set to activate visual indicators indicating that the moving robot is traveling around the target monitoring area according to the monitoring mode when the moving robot travels in a predetermined reference time.

7. The moving robot of claim 6, wherein the controller restricts operations other than traveling of the main body and image capturing of the image capturing unit when the moving robot travels around the target monitoring area in the predetermined reference time.

8. The moving robot of claim 1, wherein the controller determines a recording area of the monitoring elements based on the recording information, and sets the target monitoring area based on the recording area.

9. The moving robot of claim 8, wherein the controller, among the travel area, sets an area except the recording area as the target monitoring area.

10. The moving robot of claim 9, wherein the controller controls traveling of the main body and image capturing of the image capturing unit, so that the moving robot travels and captures around the target monitoring area of the travel area according to a predetermined monitoring reference.

11. The moving robot of claim 1, wherein the controller, when a moving object in the target monitoring area is sensed, generates notification information of a sensed result to transmit the notification information to the communication target element communicating with the communication unit.

12. The moving robot of claim 1, wherein the controller generates monitoring information based on the recording information and a result of monitoring in the monitoring mode, and transmits the monitoring information to the communication target element and the monitoring elements communicating with the communication unit.

13. A method for controlling a moving robot including a main body, a driving unit moving the main body, an image capturing unit capturing an image around the main body to generate image information of a travel area of the main body, a communication unit communicating with a monitoring element installed in the travel area to receive recording information from the monitoring element, and a controller configured to control traveling of the main body by controlling the driving unit and determine a status of the travel area based on the image information, the method comprising:
receiving the recording information from the monitoring element;
setting a target monitoring area based on the recording information;
monitoring the target monitoring area by controlling the moving robot to travel and capture an image around the target monitoring area; and
generating monitoring information of the travel area based on the recording information and a monitoring result.
